(19) United States
(12) Patent Application Publication
(10) Pub. No.: US 2026/0244437 A1
(43) Pub. Date: Aug. 20, 2026

(54) SOURCE CODE BRANCH MANAGEMENT METHOD FOR MULTIPLE RELEASE VERSIONS OF RAILWAY SOFTWARE

(71) Applicants: CHINA ACADEMY OF RAILWAY SCIENCES CORPORATION LIMITED, Beijing (CN); INSTITUTE OF COMPUTING TECHNOLOGIES, CHINA ACADEMY OF RAILWAY SCIENCES CORPORATION LIMITED, Beijing (CN); BEIJING JINGWEI INFORMATION TECHNOLOGIES LIMITED COMPANY, Beijing (CN)

(72) Inventors: Zhe WANG, Beijing (CN); Ge GUO, Beijing (CN); Weiqiao ZHU, Beijing (CN); Chengliang LIU, Beijing (CN)

(21) Appl. No.: 19/430,072

(22) Filed: Dec. 22, 2025

(30) Foreign Application Priority Data
Feb. 20, 2025 (CN) 202510186815.1

(51) Int. Cl. G06F 8/71; G06F 8/61; G06F 11/3604; G06F 11/3668

(52) U.S. Cl. CPC G06F 8/71; G06F 8/63; G06F 11/3604; G06F 11/3688

(57) ABSTRACT

The present application discloses a source code branch management method for multiple release versions of railway software. In the method, a plurality of features can be simultaneously developed by creating feature branches and developing source codes on the feature branches, and a master branch or release branches is not affected, thereby improving the development efficiency and the source code branch management efficiency. The source codes are merged to the corresponding release branch for system integration testing and function testing, the release branch is merged to a corresponding production branch after the testing are passed, and meanwhile, the source codes on a general release branch are merged to the master branch for storage, and the source codes are submitted to each customized production branch from the master branch, so that coexistence of the source codes of a general version and the source codes of a customized version is realized.

### CROSS-REFERENCE TO RELATED APPLICATION

This application claims priority to Chinese Patent Application No. CN202510186815.1, filed on February 20, 2025, which is hereby incorporated by reference in its entirety.

### TECHNICAL FIELD

The present application relates to the field of railway application software development and management technologies, and in particular, to a source code branch management method for multiple release versions of railway software.

### BACKGROUND

When the same railway application software is deployed at different places, a general version and a plurality of personalized versions need to be maintained simultaneously in consideration of personalized requirements of the places. Some functions of the general version and the personalized versions have differences, and both the general version and the personalized versions need to be continuously maintained and upgraded. The general and personalized functions need to be managed in a level of management of source codes of the software.

Existing source code branch management methods tend to only focus on the generality of the source codes and management among upgrade versions, such as a process of version upgrade from V1.2.1 to V1.2.2 to V1.2.3. A high version overwrites and replaces a low version. In the case that requirements of different customers on the functions of the software are generally consistent, and some functions need to be subjected to personalized customization but personalized contents conflict, software release cannot be performed in a version overwriting manner, that is, a software version released to customer A cannot be released to customer B. Therefore, the existing source code branch management method only focuses on the generality of the source codes and the management among the upgrade versions, and ignores the personalized customization of the source codes, so that the source code branch management efficiency is low, and the effect is poor.

### SUMMARY

An objective of the present application is to provide a source code branch management method for multiple release versions of railway software, which can improve the source code branch management efficiency and effect.

In order to achieve the above objective, the present application provides the following solution.

Disclosed is a source code branch management method for multiple release versions of railway software, wherein source code branches include a master branch, a feature branch, a hot fixing branch, a release branch and a production branch, and the master branch is configured to record and store source codes; the feature branch is configured for feature development and bug fixing work of new functions of the software; a number of the release branches is multiple, and the release branches include a general release branch oriented to a general software version and a customized release branch oriented to a personalized software version, and are configured for preparation work of software release; a number of the production branches is multiple, and the production branches include a general production branch oriented to the general software version and a customized production branch oriented to the personalized software version and are configured to deploy and release the software to a production environment; the hot fixing branch is configured to emergently fix a bug on the production branch; the source code branch management method for multiple release versions of railway software includes:

step S1: based on the software to be added with a feature, creating the corresponding feature branch according to a requirement of adding the feature, developing the source codes on the feature branch, and obtaining the source codes after the development is completed;

step S2: performing self-testing and review on the source codes, and if the self-testing and the review are passed, merging the source codes to the corresponding release branch; and if the self-testing or the review is not passed, returning to the step S1;

step S3: performing system integration testing and function testing on the source codes merged into the release branch, merging the release branch into the corresponding production branch if the integration testing and the function testing are passed, and meanwhile, if the source codes on the general release branch pass the integration testing and the function testing, also merging the source codes on the general release branch into the master branch for storage and submitting the source codes to each customized production branch from the master branch; if the integration testing or the function testing is not passed, returning to the step S1;

step S4: performing automatic code construction, packaging and storage on the source codes on the production branch to obtain an artifact;

step S5: performing acceptance testing on the artifact, and if the acceptance testing is passed, formally releasing the software corresponding to the artifact; if the acceptance testing is not passed, rolling back the merging operations in the step S2 and the step S3 on the production branch, and returning to the step S1; and

step S6: continuously monitoring a state of the software which is formally released, and when the software has unexpected failure in a running process and the source codes need to be modified, creating the hot fixing branch from the corresponding production branch, emergently fixing the product by using the hot fixing branch, then returning to the step S2, and performing the self-testing and the review by taking the emergently fixed source codes as the source codes.

Optionally, in the step S1, when the feature newly added to the software to be added with the feature is a customized feature, the feature branch is created from the customized production branch; and when the feature newly added to the software to be added with the feature is a general feature, the feature branch is created from the master branch.

Optionally, in the step S2, the self-testing includes unit testing and manual exploratory testing. The unit testing uses a unit testing tool to perform testing. The manual exploratory testing runs a developed module locally to manually verify whether an interface or a UI meets expectations. The review includes source code quality review and source code compliance review.

Optionally, the merging the release branch into the corresponding production branch in the step S3 specifically includes:

merging the customized release branch into the corresponding customized production branch, and meanwhile merging the general release branch into the general production branch.

Optionally, in the step S3, the integration testing is used to verify whether the functions meet expectations after system components of the software are integrated together; and the function testing is used to verify whether currently applied functions meet functions defined by a software requirement specification.

Optionally, the step S4 specifically includes:

according to the source codes on the production branch, automatically constructing codes by using a docker command, packaging the codes into a container image, generating the artifact, and uploading and storing the artifact to an artifact repository.

Optionally, in the step S5, the acceptance testing means that whether the software meets service requirements of a user is verified item by item according to the service requirements proposed by the user and a usage flow of the software corresponding to the artifact.

According to specific embodiments of the present application, the present application achieves the following technical effects.

The present application provides the source code branch management method for multiple release versions of railway software, the general software version and the personalized software version are considered at the same time, the general release branch oriented to the general software version, the customized release branch oriented to the personalized software version, the general production branch oriented to the general software version and the customized production branch oriented to the personalized software version are respectively designed, a plurality of features can be simultaneously developed by creating the feature branches and developing the source codes on the feature branches, and the master branch or the release branch is not affected, thereby improving the development efficiency and the source code branch management efficiency. The source codes are merged to the corresponding release branch for the system integration testing and the function testing, the release branch is merged to the corresponding production branch after the testes are passed, and meanwhile, the source codes on the general release branch are merged to the master branch for storage, and the source codes are submitted to each customized production branch from the master branch, so that coexistence of the source codes of the general version and the source codes of the customized version is realized, and a pipeline can be conveniently established from the production branch while the production environment is arranged, thus improving the source code development efficiency, and improving the source code branch management efficiency and effect.

### BRIEF DESCRIPTION OF THE DRAWINGS

In order to illustrate the technical solutions in the embodiments of the present application or the prior art more clearly, the drawings required in the embodiments will be described briefly. Apparently, the following described drawings are merely for some embodiments of the present application, and other drawings can be derived from these drawings by those of ordinary skill in the art without any creative effort.

FIG. 1 is an application environment diagram of a source code branch management method for multiple release versions of railway software according to an embodiment of the present application.

FIG. 2 is a schematic flow chart of the source code branch management method for multiple release versions of railway software according to an embodiment of the present application.

FIG. 3 is a schematic structural diagram of a source code branch model in an embodiment of the present application.

### DETAILED DESCRIPTION

The technical solutions in the embodiments of the present application are clearly and completely described with reference to the accompanying drawings of the embodiments of the present application, and apparently, the described embodiments are not all but only a part of the embodiments of the present application. All other embodiments obtained by a person of ordinary skill in the art based on the embodiments of the present application without creative efforts shall fall within the protection scope of the present application.

In order to make the aforementioned objects, features and advantages of the present application more apparent, the present application is described below in further detail with reference to the accompanying drawings and specific embodiments.

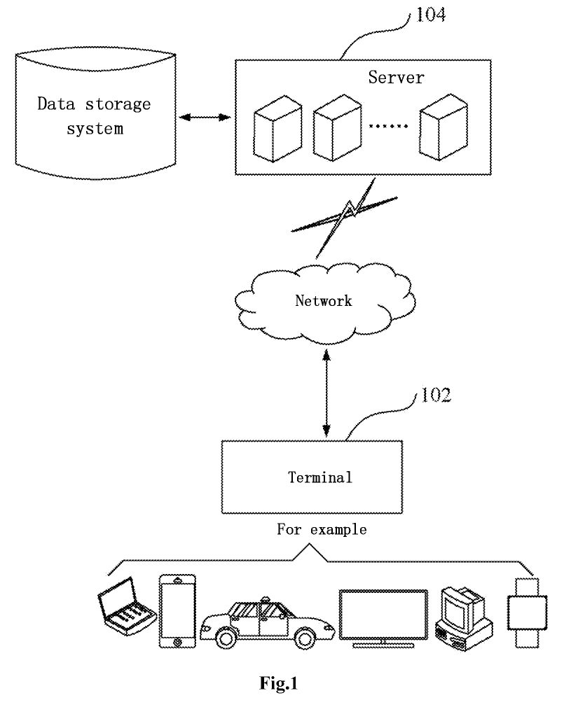

A source code branch management method for multiple release versions of railway software according to an embodiment of the present application can be applied to an application environment shown in FIG. 1. A terminal 102 is communicated with a server 104 through a network. A data storage system may store data required to be processed by the server 104. The data storage system may be independently arranged or integrated on the server 104, or may be arranged on a cloud or another server. The terminal 102 may send service requirement information, such as a requirement of adding a feature, to the server 104. After receiving the service requirement information, such as the requirement of adding the feature, for the requirement of adding the feature, the server 104, based on the software to be added with the feature, creates a corresponding feature branch according to the requirement of adding the feature, develops source codes on the feature branch, and obtains the source codes after the development is completed. The server 104 performs self-testing and review on the developed source codes, and if the self-testing and the review are passed, merges the source codes to a corresponding release branch. Then the server 104 performs system integration testing and function testing on the source codes merged into the release branch, merges the release branch into a corresponding production branch if the integration testing and the function testing are passed, and meanwhile, if the source codes on a general release branch pass the integration testing and the function testing, also merges the source codes on the general release branch into the master branch for storage and submits the source codes to each customized production branch from the master branch. The server 104 performs automatic code construction, packaging and storage on the source codes on the production branch to obtain an artifact. Then the server 104 performs acceptance testing on the artifact, and if the acceptance testing is passed, formally releasing the software corresponding to the artifact. The server 104 continuously monitors a state of the software which is formally released, and when the software has unexpected failure in a running process and the source codes need to be modified, creates a hot fixing branch from the corresponding production branch, and emergently fixes the product by using the hot fixing branch. The server 104 may feed back the released software to the terminal 102. In addition, in some embodiments, the source code branch management method for multiple release versions of railway software may be implemented by the server 104 or the terminal 102 alone. For example, the terminal 102 may directly perform source code development and source code branch management for the service requirement information, such as the requirement of adding the feature, or the server 104 may obtain the service requirement information, such as the requirement of adding the feature, from the data storage system, and perform source code development and source code branch management for the service requirement information.

The terminal 102 may be, but is not limited to, various desktop computers, notebook computers, tablet computers, or the like. The server 104 may be implemented by a stand-alone server or a server cluster composed of a plurality of servers, or may be a cloud server.

An exemplary embodiment provides a source code branch structure, source code branches mainly include a master branch, a feature branch, a hot fixing branch, release branches and production branches. The master branch is configured to record and store source codes; the feature branch is configured for feature development of new functions of the software and bug fixing work. The number of the release branches is multiple, and the release branches include a general release branch oriented to a general software version and customized release branches oriented to personalized software versions, and are configured for preparation work of software release. The number of the production branches is multiple, and the production branches include a general production branch oriented to the general software version and customized production branches oriented to the personalized software versions and are configured to deploy and release the software to a production environment; the hot fixing branch is configured to emergently fix the bug on the production branch.

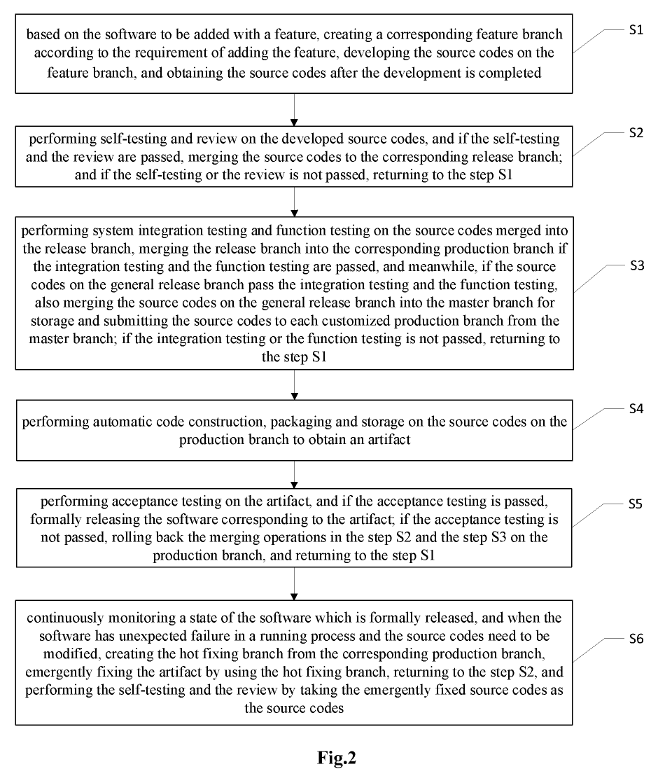

Based on the above source code branch structure, an exemplary embodiment provides a source code branch management method for multiple release versions of railway software, the method is executed by a computer device, specifically, may be executed by a computer device, such as a terminal or a server alone, or may be executed by both the terminal and the server. In the embodiment of the present application, taking the method applied to the server 104 in FIG. 1 as an example, as shown in FIG. 2, the method includes the following steps S1 to S6.

Step S1: based on the software to be added with a feature, creating a corresponding feature branch according to the requirement of adding the feature, developing the source codes on the feature branch, and obtaining the source codes after the development is completed, to implement the newly added feature.

In the present embodiment, in the step S1, when the feature to be newly added to the software is a customized feature, the feature branch is created from the customized production branch; and when the feature to be newly added to the software is a general feature, the feature branch is created from the master branch.

Step S2: performing self-testing and review on the developed source codes, and if the self-testing and the review are passed, merging the source codes to the corresponding release branch; and if the self-testing or the review is not passed, returning to the step S1.

In the present embodiment, in the step S2, the self-testing includes unit testing and manual exploratory testing. The unit testing is an automated testing process that targets the smallest testable units in software (such as individual functions, methods or classes, or a window or menu in graphical software). Its purpose is to verify whether the code of each independent "unit" functions correctly according to its design intent. The unit testing uses a unit testing tool to perform testing, and the manual exploratory testing runs a developed module locally to manually verify whether an interface or a UI meets expectations. The review includes source code quality review, source code compliance review, or the like.

In this Step S2, if the self-testing and the review on the source codes developed by the feature branch created from the customized production branch are passed, the source codes are merged to the customized release branch, and if the self-testing and the review on the source codes developed by the feature branch created from the master branch are passed, the source codes are merged to the general release branch.

Step S3: performing system integration testing and function testing on the source codes merged into the release branch, merging the release branch into the corresponding production branch if the integration testing and the function testing are passed, and meanwhile, if the source codes on the general release branch pass the integration testing and the function testing, also merging the source codes on the general release branch into the master branch for storage and submitting the source codes to each customized production branch from the master branch; if the integration testing or the function testing is not passed, returning to the step S1.

In the present embodiment, the merging the release branch into the corresponding production branch in the step S3 specifically includes: merging the customized release branch into the corresponding customized production branch, and merging the general release branch into the general production branch.

That is, after the source codes merged into the customized release branch pass the system's integration testing and functional testing, the customized release branch is merged into the customized production branch; after the source codes merged into the general release branch pass the system integration testing and functional testing, the general release branch is merged into the general production branch. At the same time, the source codes on the general release branch are merged into the master branch and saved, and submitted from the master branch to the customized production branch.

In the present embodiment, in the step S3, the integration testing is used to verify whether the functions meet expectations after system components of the software are integrated together; and the function testing is used to verify whether currently applied functions meet functions defined by a software requirement specification.

Step S4: performing automatic code construction, packaging and storage on the source codes on the production branch to obtain an artifact.

In the present embodiment, the step S4 specifically includes the following step:

according to the source codes on the production branch, automatically constructing codes by using a docker command, packaging the codes into a container image, generating the artifact, and uploading and storing the artifact to an artifact repository.

Step S5: performing acceptance testing on the artifact, and if the acceptance testing is passed, formally releasing the software corresponding to the artifact; if the acceptance testing is not passed, rolling back the merging operations in the step S2 and the step S3 on the production branch, and returning to the step S1.

In the present embodiment, in the step S5, the acceptance testing means that whether the software meets service requirements of a user is verified item by item according to the service requirements proposed by the user and a usage flow of the software corresponding to the artifact.

Step S6: continuously monitoring a state of the software which is formally released, and when the software has unexpected failure in a running process and the source codes need to be modified, creating the hot fixing branch from the corresponding production branch, emergently fixing the artifact by using the hot fixing branch, then returning to the step S2, and performing the self-testing and the review by taking the emergently fixed source codes as the source codes.

The present application provides the source code branch management method for multiple release versions of railway software, the general software version and the personalized software version are considered at the same time, the general release branch oriented to the general software version, the customized release branch oriented to the personalized software version, the general production branch oriented to the general software version and the customized production branch oriented to the personalized software version are respectively designed. By creating the feature branches and developing the source codes on the feature branches, a plurality of features can be simultaneously developed without affecting the master branch or the release branch, thereby improving the development efficiency and the source code branch management efficiency. The source codes are merged to the corresponding release branch for the system integration testing and the function testing, the release branches are merged to the corresponding production branches after the testes are passed, and meanwhile, the source codes on the general release branch are merged to the master branch for storage, and the source codes are submitted to each customized production branch from the master branch, so that coexistence of the source codes of the general version and the source codes of the customized version is realized, and a pipeline can be conveniently established from the production branch while the production environment is arranged, thus improving the source code development efficiency, and improving the source code branch management efficiency and effect.

In order to make the technical solution of the present application clearer, the following describes a specific implementation process of the present embodiment in an exemplary form.

The specific implementation process of the present embodiment includes the following steps.

Step (1): acquiring service requirement information proposed by a user, creating a corresponding feature branch according to a requirement of adding a feature in the service requirement information when software needs to be added with the feature, and developing source codes on the feature branch; wherein when the feature to be newly added to the software is a customized feature, the feature branch is created from a customized production branch; and when the feature to be newly added to the software is a general feature, the feature branch is created from a master branch.

Step (2): after the development of the source codes on the feature branch is completed, performing self-testing as well as quality and compliance review on the source codes. After the self-testing and the review are finished and passed, the source codes are merged to a corresponding release branch; if the self-testing or the review is not passed, the process returns to the step (1) to develop the source codes again. The self-testing of the source codes on the feature branch includes unit testing and manual exploratory testing, and the unit testing is performed by using a unit testing tool, such as a Junit framework. The manual exploratory testing means that a developed module is run locally, and whether an interface or a UI meets expectations is manually verified.

Step (3): performing system integration testing and function testing on the source codes merged into the release branch; if the integration testing and the function testing are passed, merging the release branch into a corresponding production branch, and meanwhile, if the testing on a general release branch is finished without problems, merging the source codes on the general release branch into the master branch for storage, and submitting the source codes to each customized production branch from the master branch. Therefore, general functions are added to the customized production branches, and the general functions of the customized production branches are kept consistent. If the integration testing or the function testing is not passed, the process returns to the step (1) to re-develop the source codes. The integration testing is used to verify whether the functions meet expectations after system components of the software are integrated together; and the function testing is used to verify whether currently applied functions of the software meet functions defined by a software requirement specification.

Step (4): based on the source codes on the production branch, automatically constructing codes through a pipeline tool by using a docker command, packaging the codes into a container image, generating an artifact, and uploading and storing the artifact to an artifact repository.

Step (5): performing acceptance testing on the artifact in the artifact repository, and if the acceptance testing is passed, formally releasing the artifact; if the acceptance testing is not passed, rolling back the submission of the merging on the production branch, and returning to the step (1), wherein the submission of the merging includes submission of direct merging of the release branch to the production branch and submission of the master branch to each customized production branch. If unexpected failure occurs in a running process and the source codes need to be modified after the artifact released by the production branch is deployed in a production environment, a hot fixing branch is created from the corresponding production branch for emergency fixing, and the testing is performed again after the fixing.

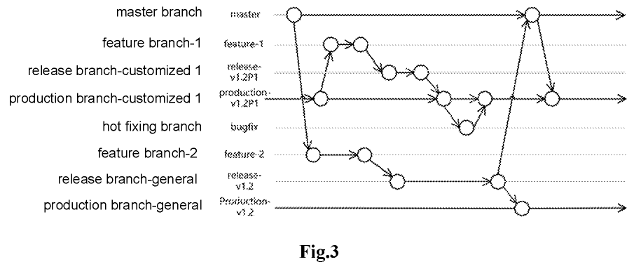

In one embodiment of the present application, the structure of a source code branch model is shown in FIG. 3, and includes five types of branches: the master branch, the feature branch, the hot fixing branch, the release branch, and the production branch, the master branch is a unique branch, and the numbers of the other branches may be one or more. The master branch is configured to record stable source codes of a general version of software and to record a change and growth condition of the source codes; the master branch can be named “master”. The feature branch is configured to develop new function features and fix bugs, and when the two operations need to be performed, the feature branch is pulled. A rule of “feature-”+“feature number” can be adopted for naming of the feature branch, such as “feature-1” and “feature-2”. The release branch is configured for release preparation work, and when preparing for a release deployment, the release branch is pulled. System testing before the release deployment is based on the release branch. At this time, no new feature development should be performed on the release branch. A naming format of the release branch can be “release-”+“version number”, such as “release-vl.2” and “release-vl.2P1”, the number of the release branches can be multiple, and the plural release branches are oriented to the general software version and the personalized software versions. The production branch is configured to deploy and release software to a production environment. A naming format of the production branch can be “production”+“version number”, such as “production-vl.2” and “production-vl.2P1”, the number of the production branches can be multiple, and the plural production branches are oriented to the general software version and the personalized software versions. The hot fixing branch is configured for emergent fixing work of bugs on the production branch. A rule of “bugfix-”+“major version number.minor version number.revision number” can be adopted for naming of the hot fixing branch.

As shown in FIG. 3, based on the software to which features are to be added and according to the requirements for the new features, a feature branch named "Feature Branch-1" is created from the customized production branch named "production-v1.2P1", and a feature branch named "Feature Branch-2" is created from the master branch "master". The source codes developed on "Feature Branch-1" and "Feature Branch-2" undergoes self-testing and review separately. If the source codes developed on "Feature Branch-1" passes self-testing and review, they are merged into the customized release branch named "release-v1.2P1". Similarly, if the source codes developed on "Feature Branch-2" passes self-testing and review, they are merged into the general release branch named "release-v1.2". The source codes merged into "release-v1.2P1" and "release-v1.2" undergoes systematic integration testing and functional testing. After the source codes merged into the customized release branch "release-v1.2P1" passes the systematic integration and functional testing, the customized release branch "release-v1.2P1" is merged into the customized production branch named "production-v1.2P1". Once the source codes merged into the general release branch "release-v1.2" passes the systematic integration and functional testing, the general release branch "release-v1.2" is merged into the general production branch "production-v1.2." At the same time, the source codes on the general production branch "production-v1.2" is merged into the master branch "master" for preservation, and then submitted from the master branch "master" to each customized production branches, such as "production-v1.2P1". The source codes on the production branches "production-v1.2" and "production-v1.2P1" undergoes automatic codes building, packaging, and storage to produce the artifacts. The artifacts then undergo acceptance testing. If the acceptance testing passes, the software corresponding to the artifacts is formally released. If an abnormal failure occurs during the operation of the artifact package deployed from the production branch "production-v1.2P1" in the production environment and source codes modifications are required, a hot fixing branch "bugfix" is created from the corresponding production branch "production-v1.2P1" for emergency fixes, followed by retesting after the fixes are applied.

In the present embodiment, the branch management specifically includes the following contents.

Performing the code development on the feature branch.

When the new feature need to be added to the software, developing the codes based on the feature branch by a developer.

Creating the feature branch from the customized production branch if the newly added feature is the customized feature; creating the feature branch from the master branch if the newly added feature is the general feature.

After the development of the codes on the feature branch is completed, and the codes are subjected to the self-testing (including the unit testing and the manual exploratory testing; the unit testing is performed using the unit testing tool, such as the Junit framework; the manual exploratory testing means that the developed module is run locally, and whether the interface or the UI meets expectations is manually verified), submitting, by the developer, a branch merging request to either the corresponding customized release branch or the general release branch.

Reviewing the branch merging request submitted by the developer and examining the quality and compliance of the source codes by a technical director (the technical director reads the submitted source codes, judges the compliance of the source codes, judges whether obvious logic errors exist or not, and judges performance optimization points; if requirements are met, the source codes are allowed to be merged, otherwise, merging with other branches is not allowed).

Performing the function testing on the release branch.

Allowing the source codes passing the review to be merged into the release branch including the customized release branch and the general release branch.

Performing, by a software tester, the system integration testing and the function testing based on the source codes on the release branch, and if problems are found in the integration testing and the function testing, performing code modification on the feature branch and resubmitting the merging request by the developer. The integration testing is used to verify whether the functions meet the expectations after the system components are integrated together; and the function testing is used to verify whether the currently applied functions meet the functions defined by the software requirement specification, and contents and testing items of the above tests are different for different testing objects.

After the integration testing and the function testing are finished, merging the codes on the release branch into the corresponding production branch, merging the customized release branch into the corresponding customized production branch, and merging the general release branch into the general production branch by the technical director.

If the testing on the general release branch is finished without issues, merging the source codes on the general release branch into the master branch for storage, and selecting and submitting the source codes to each customized production branch from the master branch, so that the general functions are added to the customized production branches, and the general functions of the customized production branches are ensured to be consistent.

Performing the acceptance testing on the production branch, and releasing the obtained product.

Continuous associating a release pipeline with the production branch, performing compiling, constructing and packaging on the basis of the source codes of the branch (the pipeline tool uses the docker command to construct and package the source codes into the container image for uploading to the artifact repository), and after the artifact is deployed and uploaded, first performing the acceptance testing. The acceptance testing means that whether a current application meets requirements is verified item by item for the service requirements put forward by the user; during the acceptance testing, a service person or a project group tester is required to perform verification for each requirement according to a use flow of the software.

When a software bug is found after the software is released, creating the hot fixing branch from the corresponding production branch for emergent fixing, and the source codes after the emergent fixing need to undergo the step (1-3) to the step (3-2) again. If the emergently fixed source codes are from the hot fixing branch created from the general production branch, the source codes are respectively merged into the master branch and the general production branch, and the source codes are selected and submitted to each customized production branch from the master branch, so that the general bugs are also fixed in each customized version.

It should be noted that one code repository corresponds to one production branch, the bug corresponds to this production branch, and if the customized production branch and the general production branch exist, the software version numbers are different, so that whether the general production branch or the customized production branch is provided can be determined by the software version numbers.

In the present embodiment, the plurality of release versions of the software are managed and maintained by maintaining the plurality of release branches and production branches, and by using the feature branch for development, a plurality of features may be simultaneously developed without influencing the master branch or the release branch. The source codes of the general version and the source codes of the customized version coexist, so that the pipeline can be conveniently created from the branches while the production environment is arranged, thus effectively improving the efficiency. In addition, the present embodiment does not involve customized feature development, and the source codes thereof can be conveniently merged into the customized production branch, which ensures that the whole customized software does not deviate from a general capability too much, thus facilitating later maintenance.

The technical features of the above-mentioned embodiments can be combined arbitrarily. In order to make the description concise, not all possible combinations of the technical features are described in the embodiments. However, as long as there is no contradiction in the combinations of these technical features, the combinations should be considered as in the scope of the specification.

The specific examples are applied herein to state the principles and implementations of the application. The description of the embodiments above is only intended to assist in understanding the method according to the present application and core ideas thereof. However, persons skilled in the art could, based on the ideas in the application, make alterations to the specific implementations and application scope. In conclusion, the content of the present specification should not be construed as placing limitations on the present application.

1. A source code branch management method for multiple release versions of railway software, wherein source code branches comprise a master branch, a feature branch, a hot fixing branch, release branches and production branches, and the master branch is configured to record and store source codes; the feature branch is configured for feature development of new functions of the software and bug fixing work; the number of the release branches is multiple, and the release branches comprise a general release branch oriented to a general software version and customized release branches oriented to personalized software versions, and are configured for preparation work of software release; the number of the production branches is multiple, and the production branches comprise a general production branch oriented to the general software version and customized production branches oriented to the personalized software versions and are configured to deploy and release the software to a production environment; the hot fixing branch is configured to emergently fix a bug on the production branch; the source code branch management method for multiple release versions of railway software comprises:
step S1: based on the software to be added with a feature, creating a corresponding feature branch according to the requirement of adding the feature, developing the source codes on the feature branch, and obtaining the source codes after the development is completed;
step S2: performing self-testing and review on the developed source codes, and if the self-testing and the review are passed, merging the source codes to the corresponding release branch; and if the self-testing or the review is not passed, returning to the step S1;
step S3: performing system integration testing and function testing on the source codes merged into the release branch, merging the release branch into the corresponding production branch if the integration testing and the function testing are passed, and meanwhile, if the source codes on the general release branch pass the integration testing and the function testing, also merging the source codes on the general release branch into the master branch for storage and submitting the source codes to each customized production branch from the master branch; if the integration testing or the function testing is not passed, returning to the step S1;
step S4: performing automatic code construction, packaging and storage on the source codes on the production branch to obtain an artifact;
step S5: performing acceptance testing on the artifact, and if the acceptance testing is passed, formally releasing the software corresponding to the artifact; if the acceptance testing is not passed, rolling back the merging operations in the step S2 and the step S3 on the production branch, and returning to the step S1; and
step S6: continuously monitoring a state of the software which is formally released, and when the software has unexpected failure in a running process and the source codes need to be modified, creating the hot fixing branch from the corresponding production branch, emergently fixing the artifact by using the hot fixing branch, returning to the step S2, and performing the self-testing and the review by taking the emergently fixed source codes as the source codes.

2. The source code branch management method for multiple release versions of railway software according to claim 1, wherein in the step S1, when the feature to be newly added to the software is a customized feature, the feature branch is created from the customized production branch; and when the feature to be newly added to the software is a general feature, the feature branch is created from the master branch.

3. The source code branch management method for multiple release versions of railway software according to claim 1, wherein in the step S2, the self-testing comprises unit testing and manual exploratory testing, the unit testing uses a unit testing tool to perform testing, the manual exploratory testing runs a developed module locally, and whether an interface or a UI meets expectations is manually verified; and the review comprises source code quality review and source code compliance review.

4. The source code branch management method for multiple release versions of railway software according to claim 1, wherein the merging the release branch into the corresponding production branch in the step S3 specifically comprises:
merging the customized release branch into the corresponding customized production branch, and merging the general release branch into the general production branch.

5. The source code branch management method for multiple release versions of railway software according to claim 1, wherein in the step S3, the integration testing is used to verify whether the functions meet expectations after system components of the software are integrated together; and the function testing is used to verify whether currently applied functions meet functions defined by a software requirement specification.

6. The source code branch management method for multiple release versions of railway software according to claim 1, wherein the step S4 specifically comprises:
according to the source codes on the production branch, automatically constructing codes by using a docker command, packaging the codes into a container image, generating the artifact, and uploading and storing the artifact to an artifact repository.

7. The source code branch management method for multiple release versions of railway software according to claim 1, wherein in the step S5, the acceptance testing verifies whether the software meets service requirements of a user item by item according to the service requirements proposed by the user and a usage flow of the software corresponding to the artifact.
